(19) United States
(12) Patent Application Publication
(10) Pub. No.: US 2008/0058490 A1
(43) Pub. Date: Mar. 6, 2008

(54) CURABLE AND CURED FLUORO-SILICONE ENCAPSULANT COMPOSITIONS

(75) Inventors: Kim Chi Thi Le, San Diego, CA (US); Shahid Murtuza, Cohoes, NY (US)

Correspondence Address: MOMENTIVE PERFORMANCE MATERIALS INC.;IP LEGAL, ONE PLASTICS AVENUE, BLDG. 51, PITTSFIELD, MA, 01201-3697, US

(73) Assignee: General Electric Company, Schenectady, NY (US)

(21) Appl. No.: 11/469,181

(22) Filed: Aug. 31, 2006

(51) Int. Cl. C08G 77/12

(52) U.S. Cl. 528/31

(57) ABSTRACT

A curable fluorosilicone composition comprising:

a) an alkenyl fluorine-containing siloxane having the formula:

MₐD_{b}D′_{c}T_{d}Qₑ

where

M=R¹R²R³SiO_{1/2};

D=R⁴R⁵SiO_{2/2};

D=R⁶R⁷SiO_{2/2};

T=R⁸SiO_{3/2}; and

Q=SiO_{4/2} with

with each R¹, R², R⁴, R⁵, R⁶ and R⁸ independently selected from the group of i) C₁ to C₁₀ monovalent hydrocarbon radicals and ii) monovalent fluorinated alkyl radicals having the formula (CH₂)_{Z}R^{f} monovalent radicals where 2≦z≦10 and R^{f} is a terminal perfluorinated alkyl group of C₁ to C₈ and each R³ and R⁷ independently selected from the group of C₂ to C₄₀ monovalent alkenyl hydrocarbon radicals, the stoichiometric coefficients a and b are non-zero and positive while the stoichiometric coefficients c, d and e are zero or positive subject to the requirement that a+c is greater than or equal to 2; the substituents R¹, R², R⁴, R⁵, R⁶ and R⁸ are chosen such that at least 30 mole percent of the sum of the silicon atoms on the M, D, D′, and T groups contain a monovalent fluorinated alkyl radical;

b) The hydrogen siloxane b) has the formula:

M′_{f}D″_{g}D′″ₕT′ᵢQ′ⱼ

where

M′=R⁹R¹⁰R¹¹SiO_{1/2};

D″=R¹²R¹³SiO_{2/2};

D′″=R¹⁴R¹⁵SiO_{2/2};

T′=R¹⁶SiO_{3/2}; and

Q′=SiO_{4/2} with

with each R⁹, R¹⁰, R¹², R¹⁴, R⁶ and R¹⁶ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R¹¹ and R¹⁵ is hydrogen, the stoichiometric coefficients f and g are non-zero and positive while the stoichiometric coefficients h, i and j are zero or positive subject to the requirement that f+g is greater than or equal to 2; and wherein the stoichiometric coefficients f and h are chosen such that the concentration of silicon-bonded hydrogen in the hydrogen siloxane ranges from about 20 to 8000 ppm by weight of the hydrogen siloxane; and

c) a hydrosilylation catalyst. The compositions of the present invention exhibit perimetric flow.

### FIELD OF THE INVENTION

The present invention relates to a fluorosilicone encapsulant composition for use in protection of electronic components and other sensitive devices.

### BACKGROUND

The protection of electronic devices and other sensitive components is of great need for many applications in harsh environments such as those exhibiting shock, thermal, and chemical hazards. An increasing number of harsh environment applications require the use of sensors, for example. Thus there exists a great need for materials that can be applied to such components. Such materials must provide not only adequate protection but also ease of use to accommodate the high speed manufacturing processes often used to produce said components. Sensitive devices and components are often subjected to an encapsulation or potting process where a liquid material is dispensed over or around the device. The liquid material is then cured to provide a protective elastomeric barrier.

There are several requirements for protective materials used in such applications. They must often be chemically resistant due to the presence of liquids or vapors that can degrade the device. Such environments are often found in transportation applications such as automotive and aerospace. Chemical applications such as storage tanks also provide the potential for chemical degradation of a device placed inside such tanks.

A protective material must also be thermally stable and exhibit a low modulus over a broad temperature range. Modulus can also be indirectly measured as hardness, with low modulus materials being soft. Thermal stability is critical for devices that are used in a variety of climates or in hot environments such as those found near motors or engines. Low modulus is important due to thermal expansions and contractions that occur for different materials in the component at different rates. Differing coefficients of thermal expansion require a soft, low modulus material that can expand and contract without placing excessive stress on the component that it is protecting.

A protective material must have the ability to be applied easily in some fashion, such as being sprayed, needle dispensed, brushed, dip-coated, or jet dispensed. Therefore the material must have appropriate rheological properties, such as low viscosity, that enable it to be easily applied. It must also have sufficient flowability such that it fills intricate crevices that are often present in small but complex devices. However, flow must often be controlled so that the dispensed material does not travel to undesired areas of the device.

Additional benefits of a protective material also include good adhesion so that the material does not become dislodged from the protected device. Additionally, transparency or translucence may be needed so that devices can be easily inspected or diagnosed in case of failure. Conversely, a pigment may be required in the composition so that the device may be inspected for full coverage of encapsulated regions or components.

Silicone compositions are potentially attractive materials for the protection of sensitive devices due to the low modulus of properly designed compositions. Silicones can also display the necessary rheological properties for convenient application. Conventional hydrocarbon-substituted silicones, however, are susceptible to degradation by species such as fuels, oils, exhaust gases, automotive fluids, and other aggressive chemicals. For this reason, fluorosilicones (i.e. silicones containing fluorinated alkyl groups) can potentially offer the dual benefit of chemical resistance and good physical properties.

Woerner has disclosed curable liquid fluorosilicone compositions (U.S. Pat. Appl. 2006/0106156 A1), but these require the use of a reinforcing filler. Such fillers can reduce the transparency of the compositions and more importantly increase viscosity and decrease flow when incorporated in amounts of any significance. They also significantly increase modulus of the cured product, which can place undesired stresses on delicate components. In U.S. Pat. No. 6,369,155, silica filler is required, as is a non-curing fluorosilicone fluid. Such non-curing fluids have the potential to migrate out of the composition in environments of high heat and/or chemical exposure and thus are often unsuitable for sensitive devices. Additionally, the composition described is based on peroxide cure which, as is known to those skilled in the art, requires high molecular weight polymers for proper cure. The compositions formulated therefrom are usually high consistency rubbers rather than liquids. Such materials are not processable by the various liquid dispense methods described above.

In U.S. Pat. No. 5,349,037, fluorosilicone compositions containing a low molecular weight vinyl-containing fluorosilicone polymer are described. Such low molecular weight polymers provide a large number of crosslinkable vinyl groups, which contribute to a higher crosslink density in the cured material. This scenario can result in an increase in hardness and modulus, which is undesirable for the reasons stated above.

### SUMMARY OF THE INVENTION

One embodiment of the present invention provides a curable composition for the protection of sensitive devices having good chemical resistance, low hardness, low modulus over a broad temperature range, dispensability as measured by viscosity, good adhesion, and translucence. Such a curable composition comprises:

a) an alkenyl fluorine-containing siloxane;

b) a hydrogen siloxane;

c) a hydrosilation catalyst;

d) an optional adhesion promoter;

e) an optional catalyst inhibitor.

The present invention also provides for a curable composition that can be dispensed perimetrically such that the dispensed material flows inward but not significantly outward.

The present invention further provides for the cured composition derived by curing the curable composition. The present invention further provides for the assembly and manufacture of devices comprising the curable or the cured composition of the present invention, e.g. electronic devices, circuit boards, chips and light emitting diodes.

The present invention provides for a curable fluorosilicone composition comprising:

a) an alkenyl fluorine-containing siloxane having the formula:

MₐD_{b}D′_{c}T_{d}Qₑ

where

M=R¹R²R³SiO₂;

D=R⁴R⁵SiO_{2/2};

D′=R⁶R⁷SiO_{2/2};

T=R⁸SiO_{3/2}; and

Q=SiO_{4/2} with

with each R¹, R², R⁴, R⁵, R⁶ and R⁸ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R³ and R⁷ independently selected from the group of C₂ to C₄₀ monovalent alkenyl hydrocarbon radicals, the stoichiometric coefficients a and b are non-zero and positive while the stoichiometric coefficients c, d and e are zero or positive subject to the requirement that a+c is greater than or equal to 2; the substituents R¹, R², R⁴, R⁵, R⁶ and R⁸ are chosen such that at least 30 mole percent of the sum of the silicon atoms on the M, D, D′, and T groups contain a monovalent fluorinated alkyl radical;

b) The hydrogen siloxane b) has the formula:

M′_{f}D″_{g}D′″ₕT′ᵢQ′ⱼ

where

M′=R⁹R¹⁰R¹¹SiO_{1/2};

D=R¹²R¹³SiO_{2/2};

D′″=R¹⁴R¹⁵SiO_{2/2};

T′=R¹⁶SiO_{3/2}; and

Q′=SiO_{4/2} with

with each R⁹, R¹⁰, R¹², R¹⁴, R⁶ and R¹⁶ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R¹¹ and R¹⁵ is hydrogen, the stoichiometric coefficients f and g are non-zero and positive while the stoichiometric coefficients h, i and j are zero or positive subject to the requirement that f+g is greater than or equal to 2; and wherein the stoichiometric coefficients f and h are chosen such that the concentration of silicon-bonded hydrogen in the hydrogen siloxane ranges from about 20 to 8000 ppm by weight of the hydrogen siloxane; and

c) a hydrosilylation catalyst. The invention also provides for compositions cured from these curable compositions and devices utilizing the cured compositions.

### BRIEF DESCRIPTION OF THE DRAWINGS

FIG. 1 shows a progressive perimetric flow of an embodiment of the compositions of the present invention as set forth in example 5.

FIG. 2 shows a progressive perimetric flow of an embodiment of the compositions of the present invention as set forth in example 6.

### DETAILED DESCRIPTION OF THE INVENTION

The alkenyl fluorine-containing siloxane a) has the formula:

MₐD_{b}D′_{c}T_{d}Qₑ

where

M=R¹R²R³SiO₂;

D=R⁴R⁵SiO_{2/2};

D=R⁶R⁷SiO_{2/2};

T=R⁸SiO_{3/2}; and

Q=SiO_{4/2} with

with each R¹, R², R⁴, R⁵, R⁶ and R⁸ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R³ and R⁷ independently selected from the group of C₂ to C₄₀ monovalent alkenyl hydrocarbon radicals, the stoichiometric coefficients a and b are non-zero and positive while the stoichiometric coefficients c, d and e are zero or positive subject to the requirement that a+c is greater than or equal to 2. The substituents R¹, R², R⁴, R⁵, R⁶ and R⁸ are chosen such that ≧30 mole percent of the sum of the silicon atoms on the M, D, D′, and T groups contain a monovalent fluorinated alkyl radical. The stoichiometric coefficients b and c are chosen such that the viscosity of the alkenyl bearing siloxane ranges from about 1000 to 50,000 centistokes at 25° C., preferably from about 3000 to 30,000 centistokes at 25° C., and most preferably from about 5000 to 20,000 centistokes at 25° C.

The hydrogen siloxane b) has the formula:

M′_{f}D″_{g}D′″ₕT′ᵢQ′ⱼ

where

M′=R⁹R¹⁰R¹¹SiO_{1/2};

D=R¹²R¹³SiO_{2/2};

D′″=R¹⁴R¹⁵SiO_{2/2};

T′=R¹⁶SiO_{3/2}; and

Q=SiO_{4/2} with

with each R⁹, R¹⁰, R¹², R¹⁴, R⁶ and R¹⁶ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R¹¹ and R¹⁵ is hydrogen, the stoichiometric coefficients f and g are non-zero and positive while the stoichiometric coefficients h, i and j are zero or positive subject to the requirement that f+g is greater than or equal to 2. The stoichiometric coefficients f and h are chosen such that the concentration of silicon-bonded hydrogen in the hydrogen siloxane b) ranges from about 20 to 8000 ppm by weight of the hydrogen siloxane, preferably from about 50 to 5000 ppm by weight of the hydrogen siloxane, more preferably from about 100 to 2500 ppm by weight of the hydrogen siloxane, and most preferably from about 200 to 1000 ppm by weight of the hydrogen siloxane. The stoichiometric coefficients g and h are chosen such that the viscosity of the alkenyl bearing siloxane ranges from about 1 to 50,000 centistokes at 25° C., preferably from about 1000 to 30,000 centistokes at 25° C., more preferably from about 2500 to 15,000 centistokes at 25° C., and most preferably from about 4000 to 10,000 centistokes at 25° C.

The amount of hydrogen siloxane b) present is chosen such that the molar ratio of silicon-bonded hydrogen to alkenyl groups in the overall formulation ranges from about 0.2 to 2.0, preferably from about 0.3 to 1.8, more preferably from about 0.5 to 1.5, and most preferably from about 0.6 to 1.2

The hydrosilation catalyst c) can be chosen from the group including but not limited to catalysts comprising rhodium, platinum, palladium, nickel, rhenium, ruthenium, osmium, copper, cobalt, iron and combinations thereof. Many types of platinum catalysts for this SiH olefin addition reaction (hydrosilation or hydrosilylation) are known and such platinum catalysts may be used for the reaction in the present instance. The platinum compound can be selected from those having the formula (PtCl₂Olefin) and H(PtCl₃Olefin) as described in U.S. Pat. No. 3,159,601, hereby incorporated by reference. A further platinum containing material usable in the compositions of the present invention is the cyclopropane complex of platinum chloride described in U.S. Pat. No. 3,159,662 hereby incorporated by reference. Further the platinum containing material can be a complex formed from chloroplatinic acid with up to 2 moles per gram of platinum of a member selected from the class consisting of alcohols, ethers, aldehydes and mixtures of the above as described in U.S. Pat. No. 3,220,972 hereby incorporated by reference. The catalysts preferred for use are described in U.S. Pat. Nos. 3,715,334; 3,775,452; and 3,814,730 to Karstedt.

The amount of hydrosilation catalyst c) present is chosen such that the concentration of the active metal center is from about 1 to 10,000 ppm by weight of the overall formulation, preferably from about 2 to 2500 ppm by weight of the overall formulation, more preferably from about 4 to 1000 ppm by weight of the overall formulation, and most preferably from about 5 to 100 ppm of the overall formulation.

The optional adhesion promoter d) can be chosen from the group including but not limited to aminoalkyl silanes, methacryloxy silanes, acryloxy silanes, isocyanurates, allyl isocyanurates, fumarates, succinates, maleates, alkoxy silanes, epoxy silanes, allylic alcohols, metal alkoxides, mercaptoalkyl silanes, allyl glycidyl ethers, silyl phosphates, bis(3-trimethoxysilylpropyl) fumarate, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group and combinations thereof.

The amount of optional adhesion promoter ranges from 0 to about 20 parts per hundred of alkenyl fluorine-containing siloxane a), preferably from about 0.02 to 10 parts per hundred of alkenyl fluorine-containing siloxane a), more preferably from about 0.05 to 5 parts per hundred of alkenyl fluorine-containing siloxane a), and most preferably from about 0.1 to 1 parts per hundred of alkenyl fluorine-containing siloxane a). When incorporated into compositions the weight ratio of adhesion promoter at the lower end of the range is slightly greater than zero.

The optional catalyst inhibitor e) may be chosen from the group including but not limited to maleates, alkynes, phosphites, alkynols, fumarates, succinates, cyanurates, isocyanurates, alkynylsilanes, vinyl-containing siloxanes, esters of maleic acid (e.g. diallylmaleate, dimethylmaleate), acetylenic alcohols (e.g., 3,5dimethyl-1-hexyl-3-ol and 2methyl-3-butyn-2-ol), amines, tetravinyltetramethylcyclotetrasiloxane and combinations thereof.

The amount of optional catalyst inhibitor e) is chosen such that the weight ratio of catalyst inhibitor e) to active catalyst metal in hydrosilation catalyst c) is from 0 to about 5000, preferably from 0 to about 2000, more preferably from 0 to about 1000, and most preferably from 0 to 500. When incorporated into compositions the weight ratio of catalyst inhibitor at the lower end of the range is slightly greater than zero.

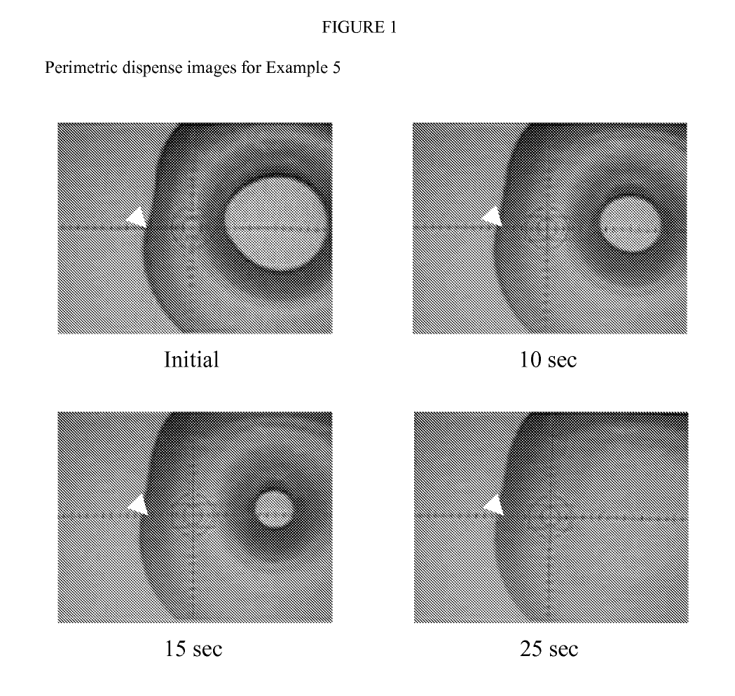

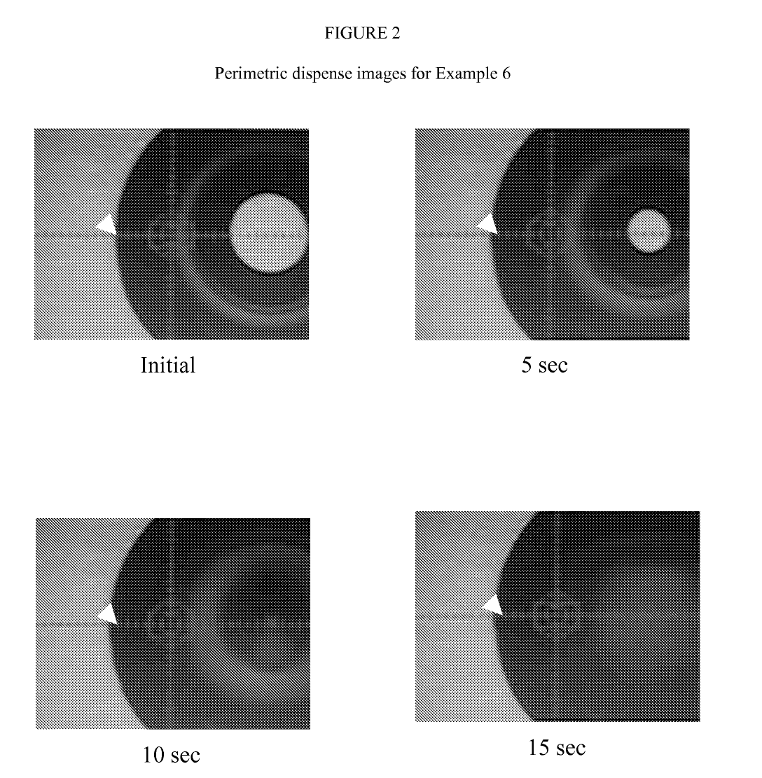

The curable compositions of the present invention exhibits unique flow properties when dispensed in a “perimetric” or closed loop pattern, such as the outline of a circle, oval, polygon, or other closed loop pattern that is either regular or irregular that forms a border or outer boundary of a two-dimensional figure. These unique flow properties include the phenomenon wherein the composition flows generally inward from the perimeter towards the center of the closed loop and does not flow significantly outward away from the center. Such an inward flow is hereby defined as a perimetric flow. Such flow is illustrated in FIGS. 1 and 2.

As is known to those skilled in the art, compositions used for the applications described above can be formulated as one-part or two-part compositions, with appropriate measures taken to optimize shelf life, pot life, work life, and cure kinetics. One part compositions typically contain all the components of the curable composition along with an inhibitor which stabilizes the composition against curing at low temperatures but which allows curing at some elevated temperature. Two part compositions generally separate the reactive components of the curable composition into two fractions until it is desired that the composition be cured wherein the two fractions are combined and cured. Such compositions may or may not contain inhibitors.

Reference is made to substances, components, or ingredients in existence at the time just before first contacted, formed in situ, blended, or mixed with one or more other substances, components, or ingredients in accordance with the present disclosure. A substance, component or ingredient identified as a reaction product, resulting mixture, or the like may gain an identity, property, or character through a chemical reaction or transformation during the course of contacting, in situ formation, blending, or mixing operation if conducted in accordance with this disclosure with the application of common sense and the ordinary skill of one in the relevant art (e.g., chemist). The transformation of chemical reactants or starting materials to chemical products or final materials is a continually evolving process, independent of the speed at which it occurs. Accordingly, as such a transformative process is in progress there may be a mix of starting and final materials, as well as intermediate species that may be, depending on their kinetic lifetime, easy or difficult to detect with current analytical techniques known to those of ordinary skill in the art.

Reactants and components referred to by chemical name or formula in the specification or claims hereof, whether referred to in the singular or plural, may be identified as they exist prior to coming into contact with another substance referred to by chemical name or chemical type (e.g., another reactant or a solvent). Preliminary and/or transitional chemical changes, transformations, or reactions, if any, that take place in the resulting mixture, solution, or reaction medium may be identified as intermediate species, master batches, and the like, and may have utility distinct from the utility of the reaction product or final material. Other subsequent changes, transformations, or reactions may result from bringing the specified reactants and/or components together under the conditions called for pursuant to this disclosure. In these other subsequent changes, transformations, or reactions the reactants, ingredients, or the components to be brought together may identify or indicate the reaction product or final material.

### EXAMPLES

Materials and equipment. “Vinyl polymer” refers to a vinyldimethylsiloxy-stopped poly(methyl3,3,3-trifluoropropyl)siloxane with the viscosity indicated for each example. “Adhesion promoter” refers to bis(3-trimethoxysilylpropyl)fumarate. “Catalyst solution” refers to a nominally 10 wt. % solution of Pt(0) in 1,3,5,7-tetravinyl-1,3,5,7-tetramethylcyclotetrasiloxane. “Hydrogen siloxane” refers to a trimethylsiloxy-stopped poly(methyl3,3,3-trifluoropropyl) (methyl hydrogen)siloxane random copolymer with an average of 100 (methyl3,3,3-trifluoropropyl)siloxy units and 10 (methyl hydrogen)siloxy units in the polymer chain.

All viscosities were measured in Ostwald tubes at 25° C. (reported in centistokes, cSt) or on a TA Instruments® AR1000 rheometer at 20° C. using a 2 cm 1 degree steel cone and plate with a shear rate of 10 sec⁻¹ (reported in centipoise, cP (cP=1.29×cSt)). Cured physical properties were measured on samples cut from sheets press cured at 150° C. for 1 hour. Modulus was measured using a TA Instruments® Ares-LS rheometer using an 8 mm parallel plate geometry and an oscillation frequency of 100 rad/sec. Die shear adhesion was measured by shearing 4 mm silicon dice with a Dage® series 4000 die shear tester with a DS100 load cell. Samples were cured at 150° C. for 1 hour then stored at ambient temperature overnight before testing. Each result is an average of ten measurements. Dispense images were captured on a glass substrate using an Asymtek® Axiom™ X-1020 dispense machine with a DV-8331 valve and auger pump at a gear ratio of 4/1. A 21 gauge quarter-inch needle was used to dispense a target weight of 17-20 mg.

### Procedure

The following mix procedure was used to prepare the compositions. The vinyl polymer was charged to a plastic cup. The adhesion promoter, catalyst solution, and hydrogen siloxane were then added with mixing between ingredients. The mixing was either for 20-40 sec at 3000 rpm in a DAC 150 SpeedMixer™ or for 45 sec at 1250 rpm in a DAC 600 SpeedMixer™. Compositions were prepared as either one-part or two-part

| | Example 1 | Example 2 |
|---|---|---|
| Vinyl polymer viscosity | 9437 cSt | 9437 cSt |
| Vinyl polymer (parts) | 100 | 100 |
| Adhesion promoter (parts) | 0.18 | 0.20 |
| Catalyst solution (parts) | 0.086 | 0.092 |
| Hydrogen siloxane (parts) | 22.8 | 30.5 |
| Shore 00 Hardness | 51 | 62 |

formulations. Examples 1 and 2 were prepared as one-part formulations:
Examples 3-7 were prepared as two-part formulations:

| | Example 3 | Example 4 | Example 5 | Example 6 | Example 7 |
|---|---|---|---|---|---|
| Vinyl polymer viscosity | 9437 cSt | 9437 cSt for A, | 8959 cSt | 8959 cSt | 9579 cSt |
| | | 10990 cSt for B | | | |
| Vinyl polymer, part A (parts) | 65.1 | 66.8 | 66.8 | 67.0 | 66.8 |
| Adhesion promoter, part A | 0.20 | 0.20 | 0.20 | 0.20 | 0.21 |
| (parts) | | | | | |
| Catalyst solution, part A (parts) | 0.098 | 0.10 | 0.10 | 0.10 | 0.10 |
| Vinyl polymer, part B (parts) | 34.9 | 33.2 | 33.2 | 33.0 | 33.2 |
| Hydrogen siloxane, part B | 30.5 | 33.8 | 33.8 | 33.8 | 33.8 |
| (parts) | | | | | |
| Carbon black, part B (parts) | 0.00 | 0.00 | 0.00 | 0.40 | 0.00 |
| Viscosity, part A | | 9821 cP | 14000 cP | 14000 cP | 15920 cP |
| Viscosity, part B | | 7313 cP | 7800 cP | 10710 cP | 9660 cP |
| Shore 00 Hardness | | | 57 | 59 | 54 |

### Modulus data for Example 3

| Temperature (deg C.) | Storage modulus (×10⁶ dyn/cm²) |
|---|---|
| −45 | 8.94 |
| 0 | 0.73 |
| 200 | 1.13 |
| 300 | 1.55 |

### Adhesion data for Example 3

| Substrate | Die shear adhesion, psi |
|---|---|
| Bare copper | 55 |
| FR4 laminate | 47 |
| Ryton^{(R)} polyphenylene | 73 |
| sulfide | |

### Fluid immersion data for Example 4, 70 hours at 150° C.

| | | Synthetic | Auto transmission | Auto transmission | Auto transmission |
|---|---|---|---|---|---|
| | Initial | motor oil | fluid Dexron III | fluid Mercon V | fluid Dexron VI |
| Shore 00 Hardness | 67 | 65 | 64 | 61 | 52 |
| Volume swell, % | — | 0.5 | 1.14 | 1.85 | 1.5 |

### Fluid immersion data for Example 4, 7 days at 25° C.

| | | ASTM | Auto |
|---|---|---|---|
| | Initial | Fuel B | antifreeze |
| Shore 00 Hardness | 67 | 66 | 67 |
| Volume swell, % | — | 20.8 | 0.66 |

The foregoing examples are merely illustrative of the invention, serving to illustrate only some of the features of the present invention. The appended claims are intended to aim the invention as broadly as it has been conceived and the examples herein presented are illustrative of selected embodiments from a manifold of all possible embodiments. Accordingly it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. Such ranges may be viewed as a Markush group or groups consisting of differing pairwise numerical limitations which group or groups is or are fully defined by its lower and upper bounds, increasing in a regular fashion numerically from lower bounds to upper bounds. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims. All United States patents (and patent applications) referenced herein are herewith and hereby specifically incorporated by reference in their entirety as though set forth in full.

Having defined the invention we claim:

1. A curable fluorosilicone composition comprising:
a) an alkenyl fluorine-containing siloxane having the formula:
MₐD_{b}D′_{c}T_{d}Qₑ
where
M=R¹R²R³SiO_{1/2};
D=R⁴R⁵SiO_{2/2};
D′=R⁶R⁷SiO_{2/2};
T=R⁸SiO_{3/2}; and
Q=SiO_{4/2} with
with each R¹, R², R⁴, R⁵, R⁶ and R⁸ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R³ and R⁷ independently selected from the group of C₂ to C₄₀ monovalent alkenyl hydrocarbon radicals, the stoichiometric coefficients a and b are non-zero and positive while the stoichiometric coefficients c, d and e are zero or positive subject to the requirement that a+c is greater than or equal to 2; the substituents R¹, R², R⁴, R⁵, R⁶ and R⁸ are chosen such that at least 30 mole percent of the sum of the silicon atoms on the M, D, D′, and T groups contain a monovalent fluorinated alkyl radical;
b) The hydrogen siloxane b) has the formula:
M′_{f}D″_{g}D′″ₕT′ᵢQ′ⱼ
where
M′=R⁹R¹⁰R¹¹SiO_{1/2};
D″=R¹²R¹³SiO_{2/2};
D′″=R¹⁴R¹⁵SiO_{2/2};
T′=R¹⁶SiO_{3/2}; and
Q′=SiO_{4/2} with
with each R⁹, R¹⁰, R¹², R¹⁴, R⁶ and R¹⁶ independently selected from the group of i) C₁ to C₁₀ monovalent hydrocarbon radicals and ii) monovalent fluorinated alkyl radicals having the formula (CH₂)_{z}R^{f} monovalent radicals where 2≦z≦10 and R^{f} is a terminal perfluorinated alkyl group of C₁ to C₈ and each R¹¹ and R¹⁵ is hydrogen, the stoichiometric coefficients f and g are non-zero and positive while the stoichiometric coefficients h, i and j are zero or positive subject to the requirement that f+g is greater than or equal to 2; and wherein the stoichiometric coefficients f and h are chosen such that the concentration of silicon-bonded hydrogen in the hydrogen siloxane ranges from about 20 to 8000 ppm by weight of the hydrogen siloxane; and
c) a hydrosilylation catalyst.

2. The composition of claim 1 wherein the composition exhibits perimetric flow when dispensed.

3. The composition of claim 2 additionally comprising an adhesion promoter.

4. The composition of claim 2 additionally comprising a catalyst inhibitor.

5. The composition of claim 4 additionally comprising an adhesion promoter.

6. The composition of claim 2 wherein the catalyst is selected from the group of catalysts comprising rhodium, platinum, palladium, nickel, rhenium, ruthenium, osmium, copper, cobalt, iron and combinations thereof.

7. The composition of claim 6 additionally comprising an adhesion promoter.

8. The composition of claim 6 additionally comprising a catalyst inhibitor.

9. The composition of claim 8 additionally comprising an adhesion promoter.

10. The composition of claim 9 wherein the adhesion promoter is selected from the group consisting of aminoalkyl silanes, methacryloxy silanes, acryloxy silanes, isocyanurates, allyl isocyanurates, fumarates, succinates, maleates, alkoxy silanes, epoxy silanes, allylic alcohols, metal alkoxides, mercaptoalkyl silanes, allyl glycidyl ethers, silyl phosphates, bis(3-trimethoxysilylpropyl) fumarate, oligosiloxanes containing an alkoxy silyl functional group, oligosiloxanes containing an aryloxysilyl functional group, oligosiloxanes containing a hydroxyl functional group, polysiloxanes containing an alkoxy silyl functional group, polysiloxanes containing an aryloxysilyl functional group, polysiloxanes containing a hydroxyl functional group, cyclosiloxanes containing an alkoxy silyl functional group, cyclosiloxanes containing an aryloxysilyl functional group, cyclosiloxanes containing a hydroxyl functional group and combinations thereof.

11. The composition of claim 9 where in the catalyst inhibitor is selected from the group consisting of maleates, alkynes, phosphites, alkynols, fumarates, succinates, cyanurates, isocyanurates, alkynylsilanes, vinyl-containing siloxanes, esters of maleic acid, acetylenic alcohols, amines, tetravinyltetramethylcyclotetrasiloxane and combinations thereof.

12. The composition of claim 10 where in the catalyst inhibitor is selected from the group consisting of maleates, alkynes, phosphites, alkynols, fumarates, succinates, cyanurates, isocyanurates, alkynylsilanes, vinyl-containing siloxanes, esters of maleic acid, acetylenic alcohols, amines, tetravinyltetramethylcyclotetrasiloxane and combinations thereof.

13. The cured composition of claim 1.

14. The cured composition of claim 2.

15. The cured composition of claim 3.

16. The cured composition of claim 4.

17. The cured composition of claim 5.

18. The cured composition of claim 6.

19. The cured composition of claim 7.

20. The cured composition of claim 8.

21. The cured composition of claim 9.

22. The cured composition of claim 10.

23. The cured composition of claim 11.

24. The cured composition of claim 12.

25. A device comprising the composition of claim 13.

26. A device comprising the composition of claim 14.

27. A device comprising the composition of claim 15.

28. A device comprising the composition of claim 16.

29. A device comprising the composition of claim 17.

30. A device comprising the composition of claim 18.

31. A device comprising the composition of claim 19.

32. A device comprising the composition of claim 20.

33. A device comprising the composition of claim 21.

34. A device comprising the composition of claim 22.

35. A device comprising the composition of claim 23.

36. A device comprising the composition of claim 24.
